(19) United States
(12) Patent Application Publication
(10) Pub. No.: US 2002/0127355 A1
(43) Pub. Date: Sep. 12, 2002

(54) Molded product for light-sensitive material, moisture-proof container for light-sensitive material and light-sensitive material package

(75) Inventors: Yoshiaki Miyake, Kanagawa (JP); Kazunori Mizuno, Kanagawa (JP); Taro Yamamoto, Kanagawa (JP); Takashi Suzuki, Kanagawa (JP); Osamu Suzuki, Kanagawa (JP)

Correspondence Address: SUGHRUE MION, PLLC, 2100 Pennsylvania Avenue, N.W., Washington, DC, 20037-3213, US

(73) Assignee: FUJI PHOTO FILM CO., LTD.

(21) Appl. No.: 10/013,660

(22) Filed: Dec. 13, 2001

(30) Foreign Application Priority Data
Dec. 13, 2000 (JP) 2000-378643
Oct. 26, 2001 (JP) 2001-329218

(51) Int. Cl. B32B 1/02; F16L 1/00; B65D 1/00; B32B 1/08; B29D 22/00; B29D 23/00

(52) U.S. Cl. 428/34.1; 428/36.4

(57) ABSTRACT

A molded product for a light-sensitive material is made by a process including a step of breaking a waterproof paper for printing paper to give a mixture of cellulose fibers and a polyolefin resin. The waterproof paper is obtained by laminating a base paper produced for printing paper with the polyolefin resin. An additional thermoplastic resin is added to the mixture if necessary. The mixture is then molded so that the ratio by weight of the base-paper-derived cellulose fibers to the total of the polyolefin resin and the additional thermoplastic resin is in the range of 51:49 to 75:25. A moisture-proof container for a light-sensitive material is also produced from a container for a light-sensitive material and a moisture-proof lining layer that are molded so that the ratio by weight of base-paper-derived cellulose fibers to the total thermoplastic resins is in the range of 51:49 to 75:25.

### BACKGROUND OF THE INVENTION

1. Field of the Invention

The present invention relates to a molded product for a light-sensitive material, and more particularly to a molded product for a light-sensitive material in which the molded product is molded from a thermoplastic resin—cellulose fiber resin mixture (hereinafter also called a ‘paper resin’) formed by kneading the thermoplastic resin with the cellulose fibers; and a light-sensitive material package that includes a light-sensitive material that is used together with the molded product.

Furthermore, the present invention relates to a moisture-proof container for a light-sensitive material, and more particularly to a moisture-proof container for a light-sensitive material in which the container is molded from a paper resin and is provided with a moisture-proof lining layer; and a light-sensitive package formed from the moisture-proof container and a light-sensitive material housed therein, the light-sensitive material being, for example, a 35 mm photographic film loaded in a cartridge.

2. Description of the Related Art

In the field of molded products for light-sensitive materials and, in particular, moisture-proof containers for light-sensitive materials and light-shielding containers for light-sensitive materials, while taking into consideration environmental issues when they are disposed of, attention has been focused on the use of resins reinforced with cellulose fibers. With regard to molded products for light-sensitive materials, packaging materials using as a main component a thermoplastic resin molded product impose a large environmental burden when disposed of after use, and reducing this environmental burden is an important task. Measures to lighten the environmental burden include a reduction in the heat generated during incineration thereby avoiding any damage to the incinerator, a reduction in the amounts of waste gases such as CO₂, NOₓ, and SOₓ, and the exclusion of environmental pollutants that are subject to regulatory control. A paper resin obtained by replacing, with cellulose fibers, a proportion of a thermoplastic resin conventionally used by itself to form a molded product is anticipated as a material that can greatly reduce such an environmental burden.

Among molded products for light-sensitive materials, with regard to molded products where the paper resin could find application, moisture-proof containers for APS format color film or 135 format color film, instant film packs, cartridges for APS color film, flanges for light-sensitive printing materials, cushioning materials, etc. can be cited. In particular, molded products for light-sensitive materials that are disposed of by the user before or after use are targeted.

Furthermore, to assure superior quality, a moisture-proof container for a light-sensitive material is required to have a moisture permeability of at most 0.5g/m²-day (according to JIS (Japan Industrial Standards) Z0208) when it is stored at 400° C. and 90% RH for 24 hours. Conventionally, in order to satisfy this requirement, a so-called double layer packaging configuration is employed, in which a light-sensitive material is housed in a plastic container which is then loaded into a presentation box. In recent years, the method for disposing of waste containers has become an important issue from an ecological viewpoint, and there is a demand for a container that is formed as a single structure using a single type of material, can be easily reused and recycled, and does not cause any environmental pollution when it is disposed of.

JP-B-8-33616 (“JP-B” means Japanese examined patent application publication) discloses an invention relating to a light-shielding sheet formed from a natural pulp type base paper and a solid content such as a resin at 3 to 70 wt %. However, there is no description of a specific application for which it is used and no mention of its moisture-proof properties when used as a container for a photographic light-sensitive material. JP-A-7-225453 (“JP-A” means Japanese unexamined patent application publication) discloses an invention relating to a light-shielding container formed from cellulose fibers and a thermoplastic resin but gives no description of its moisture-proof properties, which are essential for a container for a photographic light-sensitive material. JP-A-2000-219812 discloses an invention relating to a thermoplastic resin composition containing at least 50 wt % of non-wood natural fibers. JP-A-2000-239528 discloses an invention relating to a molding material including as a main component a mixture of plant fibers and a thermoplastic resin containing no halogen atom. This publication describes photographic properties and specifies that the amount of furfural is at most 10 μg/g of sample, but there is no detailed description of the moisture-proof properties.

### BRIEF SUMMARY OF THE INVENTION

The present invention has been carried out in view of the above-mentioned circumstances.

It is an object of the present invention to improve the performance of a molded product for a light-sensitive material and a light-sensitive material package, the molded product and the package being formed using a paper resin and, in particular, to develop a molded product for a light-sensitive material and a light-sensitive material package in which the main factors causing an adverse effect on the photographic properties can be suppressed and in which the mechanical performance is comparable to that of a 100 wt % thermoplastic resin.

Another object of the present invention is to provide a container for housing a light-sensitive material, and a light-sensitive material package, the container being molded from a paper resin and having excellent moisture-proof properties.

The above-mentioned objects of the present invention have been accomplished as follows.

A first aspect of the present invention provides the following means to solve the problem.

A molded product for a light-sensitive material made by a process including steps of breaking a waterproof paper for printing paper, the waterproof paper being obtained by laminating a base paper produced for printing paper with a polyolefin resin, to give a mixture of cellulose fibers and the polyolefin resin, adding an additional thermoplastic resin to the mixture if necessary, and molding so that the ratio by weight of the base-paper-derived cellulose fibers to the total of the polyolefin resin and the additional thermoplastic resin is in the range of 51:49 to 75:25.

Another aspect of the present invention provides the following means to solve the problem.

A light-sensitive material package including a molded product for a light-sensitive material made by a process including steps of breaking a waterproof paper for printing paper, the waterproof paper being obtained by laminating a base paper produced for printing paper with a polyolefin resin, to give a mixture of cellulose fibers and the polyolefin resin, adding an additional thermoplastic resin to the mixture if necessary, and molding so that the ratio by weight of the base-paper-derived cellulose fibers to the total of the polyolefin resin and the additional thermoplastic resin is in the range of 51:49 to 75:25, and a light-sensitive material that is used with the molded product.

Still another aspect of the present invention provides the following means to solve the problem.

A moisture-proof container for a light-sensitive material including a container for a light-sensitive material and a moisture-proof lining layer that are molded so that the ratio by weight of base-paper-derived cellulose fibers to the total thermoplastic resins is in the range of 51:49 to 75:25.

Yet another aspect of the present invention provides the following means to solve the problem.

A light-sensitive material package formed from a light-sensitive material and a moisture-proof container for housing the light-sensitive material, the container being formed from a container for a light-sensitive material and a moisture-proof lining layer that are molded so that the ratio by weight of base-paper-derived cellulose fibers to the total thermoplastic resins is in the range of 51:49 to 75:25.

The ‘total of the thermoplastic resins’ referred to in the present invention denotes the total of the polyolefin resin with which the waterproof paper for printing paper is laminated and all the thermoplastic resins that are added during a production process. The total of the thermoplastic resins includes all the thermoplastic resins used as a lining.

The light-sensitive material package is formed from a molded product for a light-sensitive material obtained by any one of the above-mentioned processes and a light-sensitive material that is used together with the molded product. In the case where the molded product for a light-sensitive material is a container, a light-sensitive material can be housed in the container to give a light-sensitive material package. A light-sensitive material can also be housed in a moisture-proof container that is formed by providing the container for a light-sensitive material with a lining layer, thus giving a light-sensitive material package.

The present inventors have found that use of the waterproof paper for printing paper, which is formed by laminating a base paper produced for printing paper with a polyolefin resin, as a paper component that is mixed with a thermoplastic resin enhances the compatibility with the thermoplastic resin and allows molded products to be produced continuously in a stable manner. It is surmised that this is due to appropriate mixing of the polyolefin resin and cellulose fibers as a result of breaking the waterproof paper for printing paper into a fibrous cellulose state, and the compatibility with other thermoplastic resins when kneading them is improved.

The above-mentioned objects, other objects, features, and advantages of the invention will become clear from the following description.

### BRIEF DESCRIPTION OF THE SEVERAL VIEWS OF THE DRAWINGS

FIG. 1 is an exploded perspective view showing the structure of an instant film pack, which is one embodiment of the present invention.

FIG. 2 is a perspective view showing a case main body and a lid for FUJICOLOR SUPERIA (registered trademark) 400, which is one embodiment of the present invention.

FIG. 3 is a graph showing the relationship between the injection pressure (MPa) and the cellulose fiber content (wt %) in one embodiment of the present invention when molding was carried out at a paper resin temperature of 170° C., the solid line denoting a case where a waterproof paper for printing paper was used and the broken line denoting a case where recycled newspaper was used.

FIG. 4 is an overall perspective view of a moisture-proof container for a light-sensitive material, which is one embodiment of the present invention.

FIG. 5 is a graph showing the relationship between the lining thickness and the moisture permeability in one embodiment of the present invention.

FIG. 6 is a cross-sectional view of a material supply device equipped with a material supply unit, which is one embodiment of the present invention.

### DETAILED DESCRIPTION OF THE INVENTION

In the present invention, ‘breaking’ means separating, mainly in its longitudinal direction, kraft pulp forming the waterproof paper for printing paper, thereby forming a plurality of cellulose fibers. In one embodiment of a breaking step, the weight-average fiber length changes from 0.40 to 0.70 mm to 0.30 to 0.50 mm.

With regard to the base paper that can be used in a molded product for a light-sensitive material and a moisture-proof container for a light-sensitive material of the present invention, plant cellulose fibers, which are generally sold as pulp, can be used. Examples of starting materials used for the pulp include softwoods such as pine, cedar, and Japanese cypress, hardwoods such as beech, oak, and eucalyptus, and non-wood fibers such as Edgeworthia chrysantha and bamboo.

In order to conserve forestry resources, much attention has been paid to the reuse of paper resources, and it is also possible to use plant cellulose fiber that has been regenerated as recycled pulp by steps such as defibering, coarse screening, aging, deinking, fine screening and bleaching using recovered paper collected from domestic, business, and public transport premises, including newspapers, weekly publications, magazines and advertising handouts, and offcuts and broke from binding and printing factories.

In the present invention it is preferable to use, as base-paper-derived cellulose fiber, a base paper produced for printing paper and/or a waterproof paper for printing paper obtained by laminating the base paper with a polyolefin resin.

In the present invention, the ‘base paper produced for printing paper’ refers preferably to a base paper that can be broken into cellulose fibers having a weight-average fiber length in the range of 0.30 to 0.50 mm. With regard to such a base paper, a base paper made from kraft pulp, etc. can be cited, and it is often used for printing paper, but a base paper that is used for other purposes can also be included in the ‘base paper produced for printing paper’ of the present invention as long as the aforementioned requirement for fiber length is satisfied. The weight-average fiber length can be measured using an optical measurement device such as that described in the examples below. The weight-average fiber length changes little from the value measured immediately after breaking to that measured during the molded product production process.

The ‘base paper produced for printing paper’ used in the present invention is preferably formed using hardwood bleached kraft pulp whose cellulose fibers, before the base paper is broken, have a weight-average fiber length in the range of 0.4 to 0.7 mm. A waterproof paper for printing paper obtained using the above-mentioned base paper is broken using a refiner, and the cellulose fibers thus obtained particularly preferably have a weight-average fiber length in the range of 0.30 to 0.50 mm as described above. When the weight-average fiber length of the cellulose fibers before breaking exceeds 0.7 mm, the kneadability with a resin tends to be degraded, and the kneading tends to require a high temperature of at least 250° C. and a long duration. When the fiber length is less than 0.4 mm, although it becomes possible to knead at a comparatively low temperature of approximately 220° C. for a short time, the precision and strength of the paper resin molded product so obtained tend to be degraded. Use of a base paper employing cellulose fibers having a weight-average fiber length in the range of 0.4 mm to 0.7 mm before breaking can give a paper resin molded product having high surface smoothness, high molding precision, and high molding strength.

The length of the cellulose fibers is preferably uniform. A uniform length for the cellulose fibers allows the kneading step and the molding step in the paper resin molded product production process to be carried out uniformly and robustly. Furthermore, the time required for these steps can be shortened, thereby preventing excessive thermal energy being applied and minimizing the adverse effects on the photographic properties from the paper resin molded product so obtained.

The ‘base paper produced for printing paper’ used in the present invention is preferably formed using a hardwood (laubholz) bleached kraft pulp (LBKP) as a starting material. A method for paper making using an LBKP is disclosed in JP-A-10-245791.

The pulp that forms the ‘base paper produced for printing paper’ used in the present invention preferably has (1) an average degree of polymerization of 800 or more, or gives (2) a pH on the base paper surface of 6.0 or more, or (3) an internal bonding force in the base paper of 10 to 20 N·cm, and it is particularly preferable for the above-mentioned requirements (1), (2) and (3) to be satisfied simultaneously.

Details of these characteristics are described in JP-A-3-149542 (Japanese registered Patent No. 2671154).

With regard to an additive that can be used in the ‘base paper produced for printing paper’, the additive is preferably chosen so that its combination does not adversely affect the photographic properties. That is to say, the additive that is used in the base paper is preferably an additive that does not adversely affect the raw stock storability of photographic light-sensitive materials, storage stability of developed prints, etc.

Such an additive includes a sizing agent (a rosin, a higher fatty acid salt, an alkylketene dimer, an alkenyl succinate, etc.), a paper strength increasing agent (polyacrylamide, etc.), a fixing agent (aluminum sulfate, etc.), a pH adjusting agent (sodium aluminate, sodium hydroxide, etc.), a filler (clay, talc, calcium carbonate, etc.), and other additives (a dye, a slime control agent, etc.).

A base paper formed by using an amphoteric polyacrylamide (JP-A-59-31949) as a paper strength increasing agent is preferably used in the present invention. A particularly useful paper strength increasing agent is an amphoteric polyacrylamide having an average molecular weight of 2,500,000 to 5,000,000, the average molecular weight being measured by gel permeation chromatography. The amphoteric polyacrylamide is an amphoteric copolymer obtained by copolymerizing an anionic monomer and a cationic monomer using as the main monomer acrylamide or methacrylamide (JP-A-6-167767). The base paper is preferably a neutral paper that has been made in a neutral region in which the pH of the paper stock is in the range of 6.0 to 7.5. When the pH exceeds the above-mentioned range, the cellulose tends to be easily hydrolyzed. When the cellulose forming the base paper undergoes hydrolysis, its molecular weight (degree of polymerization) decreases, thereby degrading the strength of the base paper. The use of a base paper with a decreased molecular weight in the manufacture of paper resin pellets causes the problems that (1) the cellulose fibers easily undergo thermal decomposition during molding; (2) the Izod impact strength is degraded; (3) an acidic gas, etc. that adversely affects photographic properties is easily generated; and so on. It is therefore preferable for the base paper to be made in the neutral region so that the paper surface has a pH of 6.0 to 7.5.

With regard to polyolefins that are used for producing waterproof paper for printing paper in which a polyolefin resin is laminated on both sides of the above-mentioned base paper, a homopolymer of an α-olefin such as polyethylene and a copolymer of α-olefins are preferred. Examples thereof include high-density polyethylene (HDPE), low-density polyethylene (LDPE), and a mixture thereof.

The molecular weight of these polyolefins is not particularly limited as long as a white pigment or a fluorescent whitener can be included in the laminated layer formed by extrusion coating, but a polyolefin having a molecular weight in the range of 20,000 to 200,000 is usually used.

The thickness of the polyolefin resin laminated layer is preferably 15 to 50 μm.

When the α-olefin homopolymer contains an additive, the additive is preferably one that does not adversely affect the raw stock storability of photographic light-sensitive materials, the storage stability of developed prints, etc. It is particularly preferable to include a white pigment, a colored pigment, and an antioxidant in the polyolefin resin laminated layer on the side on which a photographic emulsion would be coated.

A typical layer structure of the waterproof paper for printing paper has, going from the front side on which the photographic emulsion would be coated to the opposite side; an LDPE layer containing titanium dioxide and zinc stearate, a base paper layer, and a mixed LDPE and HDPE layer containing calcium stearate. Typical basis weights are 21 to 32 g/m² for the first LDPE layer, 135 to 167 g/m² for the base paper layer, and 23 to 24 g/m² for the second, mixed LDPE/HDPE layer.

The production of a paper resin in the present invention can employ a base paper produced for printing paper but preferably employs a waterproof paper for printing paper in which the above-mentioned base paper is laminated with a polyolefin resin.

With regard to an additional thermoplastic resin that can be used in the present invention, there can be cited as preferable examples polyolefins such as polyethylene (PE) and polypropylene (PP), polyesters such as polyethylene terephthalate and polybutylene terephthalate, polyamides such as nylon-6, nylon-6,6, nylon-11 and nylon-12, polystyrene, polystyrene copolymers, etc. In particular, a poly-α-olefin such as PE or PP, which has compatibility with a polyolefin resin that has been laminated on the base paper, is preferably used as the additional thermoplastic resin. The ‘additional thermoplastic resin’ referred to here denotes a separate thermoplastic resin from the polyolefin resin that has been laminated on the base paper, and does not exclude a thermoplastic resin having the same composition as that of the polyolefin resin used for the base paper lamination.

Use of an elastomer resin as a component of the thermoplastic resin can give an elastic molded product.

The molded product for a light-sensitive material of the present invention can be produced by various methods. The molded product for a light-sensitive material of the present invention is characterized in that a thermoplastic resin and a waterproof paper for printing paper, in which a base paper produced for printing paper is laminated with a polyolefin, are used as starting materials, and it is molded so that the component ratio by weight of the base-paper-derived cellulose fibers and the total of the thermoplastic resins is in the range of 51:49 to 75:25 in the molded product for a light-sensitive material that is finally obtained. The ‘total of the thermoplastic resins’ referred to here denotes the total of the polyolefin resin that is laminated on the waterproof paper for printing paper and all of the thermoplastic resins that are added during the production process. Setting the lower limit of the proportion of the cellulose fiber component at 51 wt % ensures that the cellulose fibers are present at more than 50 wt % of the whole product.

With regard to the timing of the first addition of a thermoplastic resin, a choice can be made as to whether or not a mixture of cellulose fibers and a polyolefin resin, obtained by breaking the waterproof paper for printing paper, is by itself temporarily made into pellets. An example of the process for producing a molded product without forming the above-mentioned pellets is illustrated below:

1) A step in which a waterproof paper for printing paper, in which a base paper produced for printing paper is laminated with a polyolefin resin, is broken to give a mixture of cellulose fibers and the polyolefin resin; 2) a step in which an additional thermoplastic resin that may be molten is added if necessary to the mixture obtained above; and 3) a step in which a molded product for a light-sensitive material containing the base paper and the polyolefin resin is molded so that the component ratio by weight of the base-paper-derived cellulose fibers to the total of the thermoplastic resins is in the range of 51:49 to 75:25.

An example of the process for producing a molded product involving making a mixture of cellulose fibers and a polyolefin resin, obtained by breaking the waterproof paper for printing paper, into pellets is illustrated below:

1) A step in which a waterproof paper for printing paper, in which a base paper produced for printing paper is laminated with a polyolefin resin, is broken to give a mixture of cellulose fibers and the polyolefin resin; 2′) a step in which the mixture so obtained is by itself temporarily made into pellets, the pellets so obtained are re-broken, and the broken cellulose fibers and polyolefin resin are kneaded with an additional thermoplastic resin at the same time as the re-breaking or separately; and 3) a step in which a molded product for a light-sensitive material containing the base paper and the polyolefin resin is molded so that the component ratio by weight of the base-paper-derived cellulose fibers to the total of the polyolefin resin and the additional thermoplastic resin is in the range of 51:49 to 75:25. This process is preferable since the compatibility of the cellulose fibers with the additional thermoplastic resin can be improved.

Adding 4) a step of providing a lining layer, as a simultaneous step or a separate step, to the above-mentioned step of forming a molded product for a light-sensitive material, and preferably to that of forming a container for a light-sensitive material, gives a moisture-proof container for a light-sensitive material.

The above-mentioned steps can be carried out in a continuous sequence or the mixture, etc. obtained in each of the steps can be stored temporarily.

A more detailed example of the process for producing a molded product for a light-sensitive material of the present invention is as follows.

Hereinafter, this production process example is called the ‘detailed production process example’. In the examples explained below, this ‘detailed production process example’ will be referred to.

(1) A waterproof paper for printing paper, in which a base paper produced for printing paper is laminated with a polyolefin resin, is roughly broken using a shearing machine.

(2) The waterproof paper roughly broken in this way is broken into cellulose fibers in a torn flock form by the beating action of pins using a pin mill or by the friction action between projections using a refiner.

(3) The bulky flock-form mixture of the cellulose fibers and the polyolefin resin is compression-kneaded using a pellet mill to give compact pellets.

(4) The pellets obtained in the above-mentioned step are subsequently broken using a turbomill.

(5) An additional thermoplastic resin powder is added to the mixture of cellulose fibers and polyolefin resin so broken, and they are again kneaded to form pellets using a pellet mill.

(6) The pellets containing the cellulose fibers, the polyolefin resin, and the additional thermoplastic resin obtained in the above-mentioned step are kneaded using an extruder to give paper resin pellets.

(7) The paper resin pellets thus obtained are injection-molded into the desired form using an injection-molding machine.

The above-mentioned steps can be modified in a variety of ways. For example, in the above-mentioned breaking step (4) the pellets obtained in step (3) and lumps of an additional thermoplastic resin may be broken together to give a mixture. This mixture can be supplied to the pellet mill in step (5).

In the above-mentioned step (3), it is preferable to sufficiently knead the cellulose fibers obtained in the previous step (2) and a polyolefin resin at a temperature that is equal to or exceeds the softening point of the polyolefin resin.

It is surmised that, since the molded product for a light-sensitive material of the present invention uses as a starting material a waterproof paper for printing paper, the broken polyolefin resin and the broken cellulose fibers are uniformly mixed in step (2) employing a pin mill or a refiner. It is therefore possible to achieve good mixing of the cellulose fibers, the polyolefin resin, and an additional thermoplastic resin with each other during the subsequent steps (3) to (5).

In the kneading operation in step (5) of the above-mentioned detailed production process example, the moisture content of cellulose fibers that are kneaded with a thermoplastic resin is preferably 5 wt % to 40 wt %. Maintaining this moisture content can fully utilize the resin-reinforcing function of the cellulose fibers.

A known kneading machine such as a pressure kneader can be used for the kneading.

Other preferable conditions for the kneading step are described in JP-A-5-50427.

The kneading temperature is preferably in the range of 90° C. to 220° C., and particularly preferably 140° C. to 170° C. When it is less than 90° C., the kneading tends to be insufficient, and this tendency remains slightly until the kneading temperature reaches 1 40° C. When the kneading temperature exceeds 220° C., decomposition of the cellulose is accelerated, thereby generating a large amount of components that would adversely affect the photographic light-sensitive materials.

Furthermore, in step (7) of the above-mentioned detailed production process example, the temperature at which the injection molding is carried out is preferably in the range of 140° C. to 200° C., and particularly preferably 160° C. to 170° C.

It is also possible to prepare the pellets in step (6) using an amount of thermoplastic resin that is smaller than the final amount that is to be added, and the remainder of the thermoplastic resin is added when injection-molding the molten pellets. The number of steps in which the thermoplastic resin is added and the amount thereof added can be chosen freely as long as the injection molding is carried out so that the component ratio by weight of the base paper to the total of the thermoplastic resins in the molded product is in the range of 51:49 to 75:25. The remainder of the thermoplastic resin can also be used for two-color molding or insert molding, which will be described below.

The mixing ratio by weight of the base-paper-derived cellulose fibers (plant cellulose fibers) and the total of the thermoplastic resins is in the range of 51:49 to 75:25, and preferably 60:40 to 70:30.

When mixing an additional thermoplastic resin with a waterproof paper for printing paper in which 75 parts by weight of the base paper is laminated with 25 parts by weight of a polyolefin resin, in order to ensure that 51 wt % to 75 wt % of the molded product is formed from the base-paper-derived cellulose component, 47 to 0 parts by weight of the additional thermoplastic resin is added to 100 parts by weight of the waterproof paper for printing paper.

When the proportion of the base paper component exceeds 75 wt %, the injection pressure rapidly increases, thereby making it impossible to carry out injection molding in a stable manner. This upper limit is much higher in the case where a waterproof paper for printing paper is used than is the case where cellulose fibers from recycled newspaper, etc. are used by themselves as a starting material.

In the above-mentioned injection molding step 3), if a container for a light-sensitive material (container housing a photographic film) is injection-molded using a mixture of the base-paper-derived cellulose fibers and all the thermoplastic resins, the mixture having been kneaded so as to contain at least 60 wt % of the base-paper-derived cellulose fibers (broken cellulose fibers), the paper resin container part obtained in step 3) includes at least 60 wt % of the base-paper-derived cellulose fibers made from plant fibers. In this case, there are cavities of a few μm in areas where the fibers covered with resin overlap each other, and water molecules (molecular diameter 0.265 nm) enter the container through these cavities, thereby raising the possibility of the photographic properties being degraded.

Furthermore, capillaries formed in the cavities result in capillary condensation, thereby adsorbing moisture. The Kelvin radius at 90% RH is 10.5 nm (105Å). If the capillaries are larger than this value, all moisture present at 90% RH or less can penetrate. It is therefore preferable to provide a lining layer by means of step 4), which will be described in detail below.

The molded product for a light-sensitive material of the present invention, for example, a container for a light-sensitive material, is preferably provided with, on the inner surface of the container, a thin lining layer made of the same resin as a resin that is kneaded to give the paper resin, thus preventing water molecules and moisture from entering and thereby achieving the moisture-proof properties necessary for a moisture-proof container for a light-sensitive material.

With regard to methods for providing a lining layer, there are, for example, (1) a two-color molding method, (2) an insert-molding method, and (3) a blow-molding method.

With regard to (1) the two-color molding method, there are two systems, that is to say, a moving slide core system and a rotating die system. When applied to a shape having a comparatively long hollow part such as a case for 135 format photographic film, a die slide injection system, which belongs to the rotating die system, is more suitable than the moving slide core system, which is known as a general two-color molding method.

A method for providing a case for 135 format photographic film with a lining layer by the two-color molding method is explained below. Longitudinally split halves of a 135 format case are formed on a cavity side and a core side of a die respectively, paper resin pellets are injected as a first color, and the die is opened while leaving the primary molded product in the cavity. The die is provided in an injection-molding machine and has a structure where it can be moved by a die slide mechanism. This mechanism allows the die to be moved so that the primary molded products face each other. The die is closed again, and a resin for the purpose of introducing moisture-proofing properties (a PP resin, an LCP resin, etc.) is secondarily injected so as to cover the outer peripheries of the primary molded products to give a lining layer that is integral with the primary molded products. In this case, since the primary molded products are not removed from the die, they are not cooled and can be joined to the secondary molded product to form a single piece.

Furthermore, when a moisture-proof resin is used in the primary injection and a paper resin is used in the secondary injection, a lining layer is formed on the inner face of a case.

When a lining layer is formed by (2) the insert-molding method, a moisture-proof layer having a desired thickness is molded in advance from a PP resin, an LCP resin, etc. as a primary molded product using an auxiliary die. The primary molded product is then inserted in a die for a paper resin case main body, and a paper resin is injected to give a secondary molded product. In the case of the insert-molding method, in order to improve adhesion between the primary molded product and the secondary molded product, the surface roughness (S) on the outside of the primary molded product is preferably adjusted to approximately 0.1 mm.

When a lining layer is formed by (3) the blow-molding method, a two layer blowing system is employed. In the two layer blowing system, since one of two extruders is charged with a hot molten PP, LCP, etc. resin for forming a moisture-proof layer, and the other is charged with a hot molten paper resin, one of the hot molten resin or the hot molten paper resin is guided to a die that forms the inside, and the other is guided to a die that forms the outside. Combining the extrudates gives a blow molded product. In a single layer blow molded product using a paper resin alone, the airtightness is insufficient and a parison cannot be formed when air blowing, thereby resulting in molding failure. In the case of the two layer blow system employing an airtight layer a desired parison can be obtained, thereby achieving desirable molding.

The amount of thermoplastic resin used in the lining layer is in the range in which the amount of the total of the thermoplastic resins including the thermoplastic resin present in the paper resin does not exceed 49% of the weight of the whole container. The lining layer is generally provided on the inside of a container up to the edge of an aperture, but it can be provided up to the vicinity of the edge except for a part to which a lid molded from LDPE, etc. is fitted.

The lining layer for moisture proofing has a thickness of at least 0.08 mm to maintain level of its moisture-proofing. The thickness is therefore preferably at least 0.08 mm, and more preferably at least 0.1 mm. Its upper limit is desirably determined so that the total of the thermoplastic resins present in the container are less than 49 wt %, and preferably 40 wt % or less.

Providing a lining on the inside of a container can also defend against harmful gases that adversely affect the photographic properties. A 0.08 mm thin layer can give a moisture-proof effect and shielding from photographically harmful materials that might be introduced from normal recycled paper, thereby providing a container that can house a light-sensitive material.

In the case where the above-mentioned conditions are fulfilled, the moisture-proof container for a light-sensitive material made from a paper resin can maintain a moisture permeability of 0.5 g/m² day or less, does not degrade the photographic properties, and does not cause environmental pollution.

With regard to the whole moisture-proof container for a photographic light-sensitive material of the present invention, the lower limit of the proportion of the paper component in the container exceeds 50 wt %, as a result of which it is classified as paper in terms of environmental measures, and the upper limit thereof is 75 wt %, which corresponds to an Izod impact strength of a molded product of 1.85 KJ/m². The moisture-proof container of the present invention is therefore preferable in terms of environmental conservation and at the same time has a necessary strength.

In the present invention, sealing is preferably carried out for achieving moisture proofing for a photographic light-sensitive material. A moisture permeability of 0.5 g/m² day or less is preferably maintained when measured at 40° C. and 90% RH for 1 day according to JIS Z0208. The amount of a sealant is preferably at least 4% of the weight of a moisture-proof container obtained by injection molding, and more preferably at least 6%, and the upper limit is about 10%, which corresponds to the saturation point.

When the above-mentioned conditions are fulfilled, the moisture-proof container for a photographic light-sensitive material of the present invention can maintain a moisture permeability of 0.5 g/m² day or less at 40° C. and 90% RH for 1 day, does not degrade the photographic properties, and does not cause environmental pollution.

In the above-mentioned step (3) of forming a molded product for a light-sensitive material, a molding method involving compression molding, extrusion molding, or injection molding can be employed, but in the present invention it is preferable to form a molded product for a light-sensitive material by injection molding.

In injection molding, in order to prevent aggregation and pulsations in the supply of the paper resin to an injection-molding machine, an injection-molding machine having a material supply unit that applies flexural vibration to the paper resin as it is carried downward can be employed.

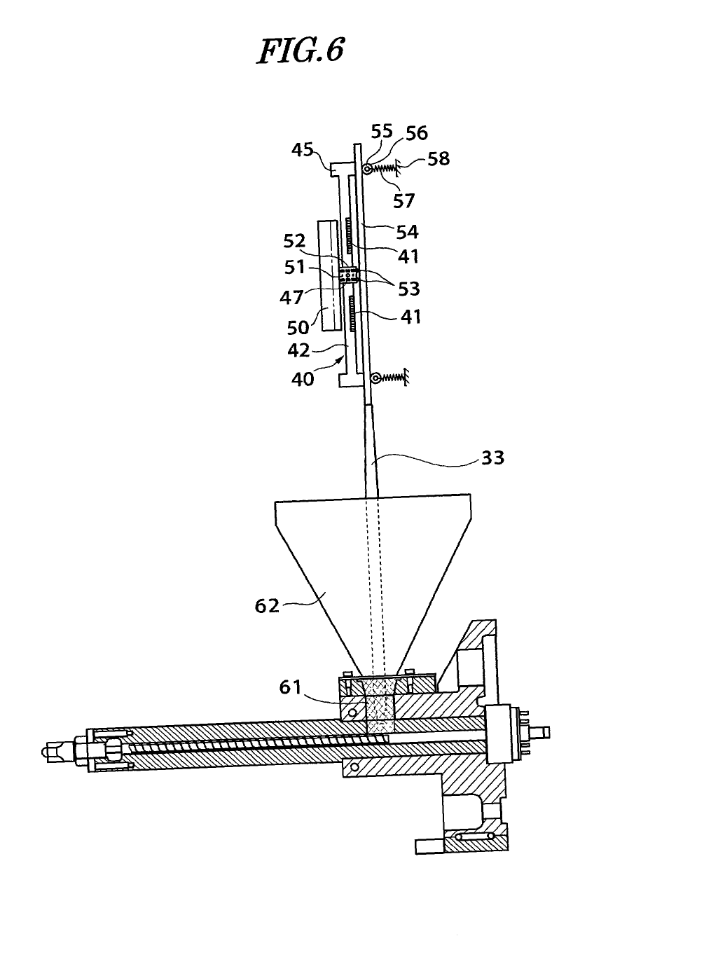

FIG. 6 is a cross-sectional view of an injection-molding machine 11 having a material supply device equipped with a material supply unit. An aluminum vibration-transmitting rod 33 that is connected to an ultrasonic vibrator 40 is disposed within a hopper 5.

The ultrasonic vibrator 40 is equipped with an elastic vibrator 42 made of hard aluminum. A cylindrical projection 47 is projectingly provided on a side face in the central part of the elastic vibrator 42, the central part becoming a vibration node. Frictional parts 45 are formed so as to project orthogonally out of opposite ends of the elastic vibrator 42. Laminated piezoelectric devices 41 are inserted, as electromechanical energy converting devices, into two channels in the vibrator 42 formed on parts corresponding to antinodes of the secondary flexural vibration of the elastic vibrator 42.

The laminated piezoelectric devices 41 are formed by layering piezoelectric devices having a thickness of 0.1 mm, a width of 4 mm, and a depth of 30 mm (for example, Pb(Mg_{⅓}·Nb_{⅔})O₂-PbTiO₂-PbZrO₃(PZT-PMN system)). An alloy of silver and palladium is coated at 2 positions in the width direction on one surface of the piezoelectric devices, thereby forming electrodes. A piezoelectric sheet laminate is formed by alternately layering approximately 40 sheets in total of the piezoelectric devices and insulating piezoelectric devices, the insulating piezoelectric devices being formed from the same material as that of the piezoelectric devices but having no electrodes attached. Corresponding electrodes of the devices so laminated are electrically connected together, thus forming a pair of external electrodes.

FIG. 6 shows the structure of a vibration transmitting section that transmits the vibration generated by the ultrasonic vibrator 40 to a powder to vibrate it. A support 51 is orthogonally provided on opposite sides of the central part on a platform 50. Formed on the central part of the support 51 is a semicircular recess whose size corresponds to the diameter of the projection 47 projectingly provided on the ultrasonic vibrator 40; the projection 47 is fitted into the recess and fixed by retainers 52 and 53. A vibrator rod slider 54 for transmitting vibration is clamped with a constant pressure between the two frictional parts 45 of the ultrasonic vibrator 40 and two crimping rollers 55. The crimping rollers 55 are fixed to fixtures 58 via bearings 56 and springs 57. Vibration generated by the vibrator 40 is thereby transmitted to the vibration transmitting rod 54 while minimizing mechanical loss.

In injection molding, in order to continuously supply a paper resin to a molding machine screw in a stable manner, it is preferable to use a material supply unit made of a material satisfying the requirements that the coefficient of sliding friction between the paper resin and the material forming a powder outlet 61 on the lower end of a resin powder supply hopper 62 is 0.15 or less; and that the static charge generated by the paper resin passing through the outlet is 1.5 kV or less. This allows a necessary amount of the resin to be fed to the molding machine without causing adhesion of resin to the cylindrical surface of the hopper or jams as the resin is conveyed.

With regard to the material forming the powder outlet, glass having a surface roughness (S) of 0.5 mm or less is preferable, and hard glass having a surface roughness (S) of 0.5 mm or less is particularly preferable. Specific examples of the glass include quartz glass, 96% quartz glass, and borosilicate glass. The surface roughness of the powder outlet denotes the average distance between projections and depressions on the inner wall of the powder outlet. Details of a method for its measurement are specified in JIS B0601.

It is also possible to use a conventional material such as stainless steel as the material forming the powder outlet by coating it with a ceramic and polishing it so that the surface roughness becomes 0.5 or less. Examples of the coating material include TiO₂, AI₂O₃ and B₂O₃. More specifically, for example, SUS 316 that has been subjected to mirror finishing (S of 0.5 mm or less) is subjected to detonation thermal spraying with TiO₂, and then polishing so that the surface roughness (S) becomes 0.5 mm or less.

Furthermore, a silicone resin, a Teflon resin, etc., which have a low coefficient of friction, can also be used. In this case, in order to eliminate static electricity it is necessary to knead with carbon black, etc., thereby maintaining the volume resistivity at 10⁸Ω·cm or less.

It is preferable to supply a powder obtained by re-breaking paper resin pellets obtained in the detailed production process example step (6) to the above-mentioned injection-molding machine, but it is also possible to supply pellets obtained in any of the detailed production process example steps, a broken material obtained during any of the steps, etc.

With regard to molded products for photographic light-sensitive materials that can be produced using the paper resin obtained in the present invention, there are, for example, a container and its associated member for a photographic light-sensitive material, a light-shielding container and its component member for a photographic light-sensitive material, a moisture-proof container and its associated member for a light-sensitive material, a moisture-proof container and its associated member for photographic color paper and, in particular, a moisture-proof container and its component member housing a light-shielding container (cartridge) for photographic film (a moisture-proof container (including a cover) for 135 format film cartridge, a 135 format spool, a magazine for an APS format film, an instant film pack, a 110 format film cartridge, a cuboid-shaped magazine housing a light-sensitive material for printing, a paper tube around which a long length of light-sensitive material is wound, a flange for winding up a long length of light-sensitive material and retaining the opposite sides thereof, a cushion material that is placed in a container for a light-sensitive material, supporting board for a light-sensitive material laminate (thick board that is in contact with a light-sensitive material laminate), etc.), and a film container equipped with a lens (registered trademark ‘Utsurundesu’).

The molded product for a light-sensitive material and the moisture-proof container for a light-sensitive material of the present invention can be used not only for 135 format but also for other photographic films such as APS format that require a plastic case packaging for moisture proofing. In addition, the moisture-proof container of the present invention can be used for a spool, a magazine, a film pack, a film body equipped with a lens, etc.

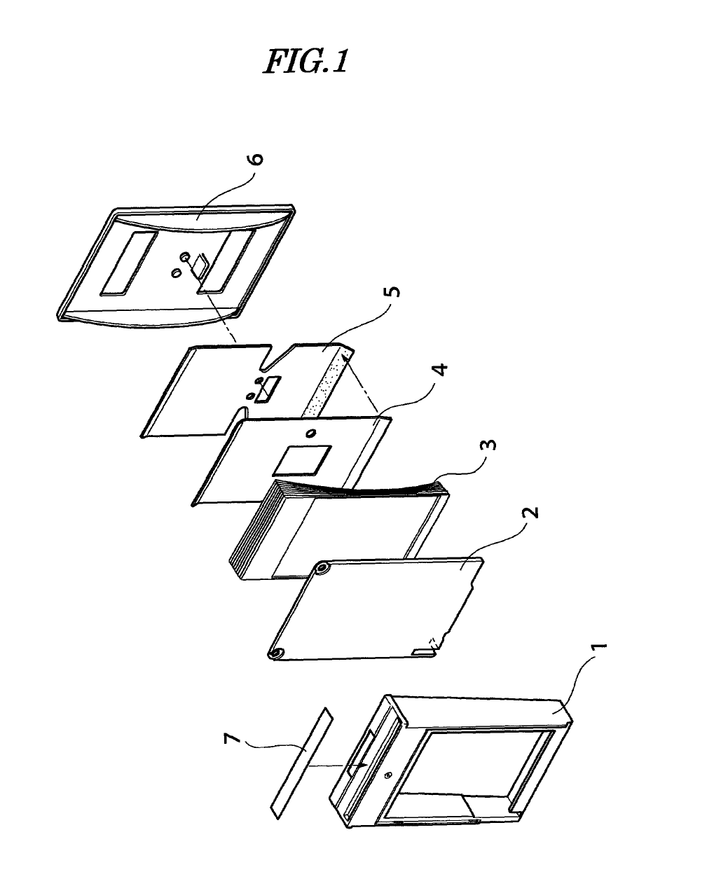

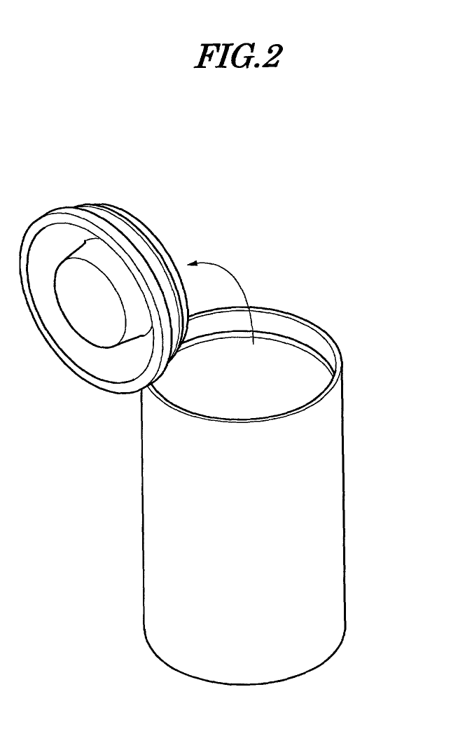

For example, FIG. 1 illustrates an instant film pack, which is one embodiment of the present invention. The instant film pack includes a case main body 1, a film cover 2, a light-shielding sheet 4, a light-shielding sheet 5, a base plate 6, and a flap 7. The above-mentioned components 1 to 6 employ resin molded products, and the molded products of the present invention can be applied to a part or the whole of these components. The components, together with a film 3, can be made into a light-sensitive material package. FIG. 2 illustrates a moisture-proof container for a 135 format film cartridge, which is one embodiment of the present invention. This container, together with a 135 format film, can be made into a light-sensitive material package.

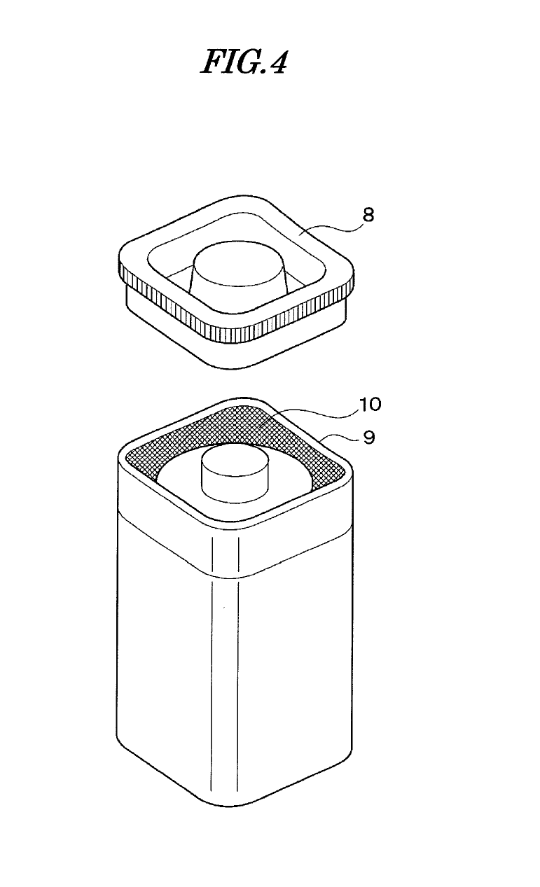

Furthermore, FIG. 4 illustrates a light-sensitive material package that includes a moisture-proof container for a 135 format film cartridge and a 135 format film housed in the moisture-proof container, which is one embodiment of the present invention. The moisture-proof container is formed from a cap 8 and a case main body 9 formed from a paper resin. A lining layer 10 is provided on the inside of the case main body. The container, together with a 135 format film, can form a light-sensitive material package.

In order to introduce light-shielding performance to a paper resin, the addition of 0.05 to 25 wt % of a light-shielding material thereto can improve the light-shielding function that is required for a molded product used on the periphery of a photographic light-sensitive material without degrading the chemical and physical properties of the paper resin. When the amount is less than 0.05 wt %, light-shielding performance cannot be exhibited, which not only fails to achieve the object of the addition, but also increases the cost. When the amount exceeds 25 wt %, the physical strength is degraded and at the same time the appearance becomes poor.

Examples of the light-shielding material that can be added in order to introduce light-shielding performance are as follows:

### (1) Inorganic compounds

A. Oxides

Silica, diatomaceous earth, alumina, titanium oxide, iron oxide, zinc oxide, magnesium oxide, antimony oxide, barium ferrite, strontium ferrite, beryllium oxide, pumicite, pumicite balloons, alumina fibers, etc.

B. Carbonates

Calcium carbonate, magnesium carbonate, dolomite, dawsonite, etc.

C. Silicates

Talc, clay, mica, asbestos, glass fiber, glass balloons, glass beads, calcium silicate, montmorillonite, bentonite, etc.

D. Carbon

Carbon black, graphite, carbon fiber, hollow carbon spheres, etc.

E. Others

Iron powder, copper powder, lead powder, tin powder, stainless steel powder, pearl pigment, aluminum powder, molybdenum sulfide, boron fiber, silicon carbide fiber, yellow copper fiber, potassium titanate, lead titanate zirconate, zinc borate, barium metaborate, calcium borate, sodium borate, aluminum paste, talc, etc.

### (2) Organic compounds

Wood powder (pine, oak, sawdust, etc.), husk fiber (almond, peanut, chaff, etc.), various types of colored fiber such as cotton and jute, paper pieces, cellophane pieces, nylon fiber, polypropylene fiber, starch, aromatic polyamide fiber, etc.

Among the above-mentioned light-shielding materials, carbon black is preferred since it can suppress the degree of bleed-out. Particularly preferable examples of the class of carbon black starting material include gas black, furnace black, channel black, anthracene black, acetylene black, Ketjen carbon black, lamp black, lamp soot, pine soot, animal black, vegetable black, etc.

In the present invention, in order to improve the light-shielding performance, the cost efficiency, and the physical properties, furnace carbon black is preferred; as a light-shielding material having an antistatic effect acetylene carbon black and Ketjen carbon black, which is a modified synthetic carbon black, are preferred although they are expensive. It is also preferable to mix the former and the latter so as to meet performance requirements as necessary.

There are various modes for preparing a light-shielding material, but a master batch method is preferable in terms of cost, prevention of contamination of the workplace, etc. JP-B-40-26196 discloses a method for preparing a polymer-carbon black master batch by dispersing carbon black in a solution of a polymer dissolved in an organic solvent, and JP-B-43-10362 discloses a method for preparing a master batch by dispersing carbon black in polyethylene.

Among various types of carbon black that are used in the molded product for a photographic light-sensitive material of the present invention, carbon black having a pH of 6.0 to 9.0 and an average particle size of 10 to 120 μm is preferred since fog is not caused in a photographic light-sensitive material, changes in photographic sensitivity are suppressed, the light-shielding ability is high, and the occurrence of pinholes due to the formation of lumps of carbon black and fisheyes is suppressed even when it is added to the resin composition in the present invention. Among the above-mentioned types of carbon black, in particular, furnace carbon black having a volatile component content of 2.0% or less and an oil adsorption of 50 ml/100 g or more is preferred. Channel carbon black is expensive and tends to cause undesirable fog in a photographic light-sensitive material. When its use is required, it should be chosen after examining its influence on the photographic properties.

Examples of preferable commercial products available in Japan include Carbon black #20(B), #30(B), #33(B), #40(B), #44(B), #45(B), #50, #55, #100, #600, #2200(B), #2400, #950(B), MA8, MA11 and MA100 (all manufactured by Mitsubishi Chemical Corp.).

Examples of commercial products available outside Japan include Black Pearls 2, 46, 70, 71, 74, 80, 81, 607, etc., Regal 300, 330, 400, 660, 991, SRF-S, etc. Vulcan 3, 6, etc., and Sterlin 10, SO, V, S, FT-FF, MT-FF, etc. (all manufactured by Cabot). Furthermore, the examples include Printex-Alfa and Printex-90 (all manufactured by Degussa-Huls). However, they are not cited to limit the scope of the present invention.

The amount of light-shielding material added is usually 0.05 to 25 wt % relative to the weight of the final molded product, preferably 0.1 to 15 wt %, more preferably 0.5 to 10 wt %, and most preferably 1.0 to 7.0 wt %.

Since the paper resin in the present invention has a low melt flow rate (MFR) in comparison with a thermoplastic resin alone, a lubricant can be added as long as the effect of the present invention is not degraded.

The names of typical lubricants that can be used in the paper resin in the present invention and their manufacturers' names are listed below.

(1) Silicone type lubricants

Various grades of dimethylpolysiloxane and modified compounds thereof (Shin-etsu Silicone Co., Ltd., Toray Silicone, Inc.)

(2) Oleamide type lubricants

Armoslip CP (Lion Akzo), Neutron (Nippon Seika), Neutron E-18 (Nippon Seika), Amido 0 (Nitto Chemical), Alfro E:10 (NOF), Diamid 0-2000 (Nippon Kasei), Diamid C-200 (Nippon Kasei), etc.

(3) Erucamide type lubricants

Alfro-F-10 (NOF), etc.

(4) Stearamide type lubricants

Alfro-S-10 (NOF), Neutron 2 (Nippon Seika), Diamid 200 (Nippon Kasei), etc.

(5) Bisfatty acid amide type lubricants

Bisamide (Nippon Kasei), Diamid 2000 Bis (Nippon Kasei), Armowax BBS (Lion Akzo), etc.

(6) Nonionic surfactant type lubricants

Electrostripper TS-2, Electrostripper TS-3 (Kao), etc.

(7) Hydrocarbon type lubricants

Liquid paraffin, natural paraffin, microwax, synthetic paraffin, polyethylene wax, polypropylene wax, chlorinated hydrocarbons, fluorocarbons.

(8) Fatty acid type lubricants

Higher fatty acids (preferably those having 12 carbons or more), oxyfatty acids.

(9) Ester type lubricants

Lower alcohol esters of fatty acids, polyhydric alcohol esters of fatty acids, polyglycol esters of fatty acids, fatty alcohol esters of fatty acids

(10) Alcohol type lubricants

Polyhydric alcohols, polyglycols, polyglycerols.

(11) Metallic soaps

Compounds of a higher fatty acid such as lauric acid, stearic acid, ricinoleic acid, naphthenic acid or oleic acid and a metal such as Li, Mg, Ca, Sr, Ba, Zn, Cd, Al, Sn or Pb.

### EXAMPLES

Examples and comparative examples are explained below, but they are not intended to limit the present invention.

### Example 1

As a starting material a waterproof paper for printing paper was used that was formed by laminating a polyolefin resin on a base paper that had been produced for printing paper using hardwood bleached kraft pulp (LBKP) having a weight-average fiber length of 0.7 mm measured using a FS-100 measuring machine manufactured by Kajaani Co. This waterproof paper for printing paper was formed by laminating 25 parts by weight of a PE resin on 75 parts by weight of the base paper. The waterproof paper for printing paper was broken using a pin mill to give broken sample 1. Broken sample 1 was compression-kneaded using a pellet mill as described in the above-mentioned detailed production process example step (3) to give compact pellets, which were subsequently broken in a turbomill as described in the above-mentioned detailed production process example step (4) to give broken sample 2. The weight-average fiber length of broken sample 2 was found to be 0.45 mm by microscope measurement.

100 parts by weight of broken sample 2 and 89 parts by weight of a PP resin, which was an additional thermoplastic resin, were subjected to the above-mentioned detailed production process example steps (5) and (6) to give paper resin pellets having a base-paper-derived cellulose fiber content of 40 wt %.

The above-mentioned procedure was repeated except that the amount of PP resin added was changed as shown in Table 1, and paper resin pellet sample Nos. 1 to 7 having different base-paper-derived cellulose fiber contents were obtained. Paper resin pellet sample No. 8 was prepared using a base paper that had not been laminated with a PE resin and its base-paper-derived cellulose fiber content was 80 wt %.

Paper resin pellet sample Nos. 2 to 7 correspond to the examples, and paper resin pellet sample Nos. 1 and 8 correspond to the comparative examples.

TABLE 1

| | | | Base-paper-derived |
|---|---|---|---|
| | Broken sample 2 | Additional PP resin | cellulose fiber |
| No. | (parts by weight) | (parts by weight) | content (wt %) |
| 1 | 100 | 89 | 40 |
| 2 | 100 | 47 | 51 |
| 3 | 100 | 37 | 55 |
| 4 | 100 | 25 | 60 |
| 5 | 100 | 15 | 65 |
| 6 | 100 | 7.5 | 70 |
| 7 | 100 | 0 | 75 |
| 8 | 80 | 20 | 80 |
| | *Note | | |

*Note)
80 Parts by weight of base paper without laminated PE resin was used. The production method was the same as in the case where a waterproof paper for printing paper was used.

Instax mini (registered trademark, manufactured by Fuji Photo Film Co., film cases were injection-molded using paper resin pellet sample Nos. 1 to 8 obtained above with 0.5 wt % of carbon black #950 (manufactured by Mitsubishi Chemical Corp.) and 0.5 wt % of KF 96 silicone oil (manufactured by Shin-etsu Chemical Co., Ltd.) added when molding. The injection molding was carried out using a GS-180 injection-molding machine (manufactured by Sumitomo Heavy Industries, Ltd.) using a die with a cold runner having a diameter of 1.2 mm at a die temperature of 80° C. and a paper resin temperature of 170° C. The results of measuring the physical properties of the above-mentioned paper resin pellets and various characteristics of the instax mini film cases are given in Tables 2 and 3. The measurement conditions were according to JIS K7110. The MFR (melt flow rate) was measured at 125° C. with a load of 3.19 N and a sample size of 8 g.

TABLE 2

| | Paper resin No. | | | | |
|---|---|---|---|---|---|
| | 1 | 2 | 3 | 4 | 5 |
| Base-paper-derived cellulose fiber | 40 | 51 | 55 | 61 | 65 |
| content wt % | | | | | |
| Density g/cm³ (JIS K7112) | 1.08 | 1.11 | 1.11 | 1.12 | 1.12 |
| MFR g/10 min (JIS K7210) | 6 | 4 | 3.8 | 3.2 | 3.0 |
| Tensile stress MPa (JIS K7113) | 27 | 39 | 43 | 50 | 53 |
| Tensile elongation at break % (JIS | 1.8 | 2.6 | 3.0 | 3.4 | 4.0 |
| K7113) | | | | | |
| Flexural strength MPa (JIS K7203) | 38 | 54 | 66 | 69 | 73 |
| Flexural modulus MPa (JIS K7203) | 3,800 | 3,100 | 3,000 | 2,700 | 2,500 |
| Izod impact KJ/m² (JIS K7110) | 2.1 | 2.2 | 1.9 | 1.87 | 1.8 |

| | Paper resin No. | | | Ref. |
|---|---|---|---|---|
| | 6 | 7 | 8 | PP |
| Base-paper-derived cellulose fiber | 70 | 75 | 80 | 0 |
| content wt % | | | | |
| Density g/cm³ (JIS K7112) | 1.13 | 1.14 | 1.14 | 0.91 |
| MFR g/10 min (JIS K7210) | 2.0 | 1.4 | 0.8 | 15 |
| Tensile stress MPa (JIS K7113) | 58 | 60 | 61 | 270 |
| Tensile elongation at break % (JIS | 4.6 | 5.1 | 5.8 | 200 |
| K7113) | | | | |
| Flexural strength MPa (JIS K7203) | 79 | 85 | 90 | 300 |
| Flexural modulus MPa (JIS K7203) | 2,220 | 2,000 | 1,900 | 10K |
| Izod impact KJ/m² (JIS K7110) | 1.76 | 1.65 | 1.6 | 5.0 |

TABLE 3

| | Characteristics of film case formed | | | | |
|---|---|---|---|---|---|
| | from paper resin No. | | | | |
| | 1 | 2 | 3 | 4 | 5 |
| Base-paper-derived | 40 | 51 | 55 | 61 | 65 |
| cellulose fiber | | | | | |
| content wt % | | | | | |
| Photographic | 0.02 | 0.02 | 0.02 | 0.02 | 0.02 |
| property ΔDmax | | | | | |
| Injection pressure | 6.0 | 6.5 | 6.7 | 6.8 | 7.3 |
| MPa | | | | | |
| Moldability | A | A | A | B | B |
| Incineration | 7000 | 6400 | 4900 | 4200 | 3600 |
| calories kcal/kg | | | | | |
| Brittleness | A | A | A | B | C |

| | Paper resin No. | | | Ref. |
|---|---|---|---|---|
| | 6 | 7 | 8 | PP |
| Base-paper-derived | 70 | 75 | 80 | 0 |
| cellulose fiber | | | | |
| content wt % | | | | |
| Photographic | 0.02 | 0.03 | — | 0.01 |
| property ΔDmax | | | | |
| Injection pressure | 7.5 | 8.4 | 9.1 | 4.3 |
| MPa | | | | |
| Moldability | B | C | D | A |
| Incineration | 2800 | 2100 | 1400 | 10500 |
| calories kcal/kg | | | | |
| Brittleness | C | C | D | A |

The results of evaluation of the moldability are expressed as follows: A; the maximum initial injection pressure of the molding machine was 6.7 MPa or less, B; 6.8 to 7.5 MPa, C; 7.6 to 8.5 MPa, D; 8.5 MPa or above.

Brittleness was evaluated by loading a predetermined amount of film in a film case, dropping it from a height of 76 cm onto hard wooden board (made of oak, 30 mm thick), and visually observing the state of breakage of the case. The results of evaluation of the brittleness are expressed as A for no abnormality in the case, B for a slight deformation of the case without splits or cracks, C for a crack in the case, and D for a split in the case.

### Example2

A moisture-proof case main body for housing FUJICOLOR SUPERIA (registered trademark) 400 was molded using the paper resin pellets produced in Example 1.

The die had a four-branch valve gate system with a valve diameter of 2 mm. The die temperature was 70° C. The molding machine was a Sumitomo SG180. The paper resin temperature was 170° C.

For a lid for the main body, elastic paper resin pellets were prepared by mixing 100 parts by weight of the broken sample 2 produced in Example 1, 20 parts by weight of a PP resin, and 24 parts by weight of an elastomer, and introducing elasticity in accordance with the methods of the above-mentioned detailed production process example steps (5) and (6). The paper resin lid was molded using the above-mentioned paper resin pellets in a four-branch lid die under the same molding conditions as those used for the main body case.

The lids were used for all the main body cases having different compositions, and the properties of the sealed moisture-proof cases were evaluated.

Evaluation of the moisture proofness was carried out as follows. The main body cases were loaded with 10.0 g of calcium chloride for measurement of moisture proofness together with a FUJICOLOR SUPERIA 400 135 format film, and then fitted with the lids to complete the sealed products. The samples so obtained were allowed to stand in an oven at 40° C. and 90% RH for 24 hours, the weight of the calcium chloride was measured to determine the increase in weight, and the moisture permeability was calculated by conversion.

An increase in the minimum density due to change over time was denoted by ΔDmin.

The results of the evaluation are given in Table 4.

TABLE 4

| | Base-paper-derived | Moisture | | Photographic |
|---|---|---|---|---|
| Sample | cellulose fiber | permeability | | property |
| No. | content wt % | g/m² · day | Moldability | ΔDmin |
| 1 | 40 | 4 | A | 0.009 |
| 2 | 51 | 10 | A | 0.010 |
| 3 | 55 | 10.5 | A | 0.010 |
| 4 | 60 | 11 | B | 0.012 |
| 5 | 65 | 13 | B | 0.014 |
| 6 | 70 | 15 | C | 0.018 |
| 7 | 75 | 16 | C | 0.019 |

For a paper resin, the higher the base paper content, the higher the moisture permeability.

### Example 3

Broken material 2 was obtained in the same manner as in Example 1 using base papers that gave cellulose fiber weight-average fiber lengths after breaking of 0.3, 0.50, 0.70, 0.90, and 0.95 mm. Paper resin pellets were produced according to the above-mentioned detailed production process example by mixing 100 parts by weight of the broken material 2 with 47 parts by weight of a PP resin. A 135 format film case was molded in the same manner as in Example 2 using the paper resin pellets, and the moldability and the moisture permeability were evaluated. The results are given in Table 5.

TABLE 5

| Weight- | Moisture | Photographic | | |
|---|---|---|---|---|
| average fiber | permeability | property | | |
| length mm | g/m² · day | ΔDmin | Moldability | Note |
| 0.25 | 4.0 | 0.050 | D | Cellulose easily |
| | | | | decomposed |
| | | | | by heat |
| 0.30 | 4.0 | 0.020 | A | |
| 0.45 | 10.0 | 0.010 | A | |
| 0.50 | 10.3 | 0.010 | A | |
| 0.60 | 10.4 | 0.090 | C | |
| 0.70 | 10.9 | 0.090 | D | Injection |
| | | | | pressure high |

When the weight-average fiber length after breaking was less than 0.30 mm, the cellulose fiber was susceptible to thermal decomposition during molding, generating aldehyde. In terms of the photographic properties, the ΔDmin undesirably increased. When the weight-average fiber length after breaking exceeded 0.50 mm, the kneading by the screw of the molding machine was poor, and the injection pressure during molding increased, thus undesirably resulting in the so-called “short shot” defect.

### Example 4

Paper pellets were produced by the production process described in the above-mentioned detailed production process example using a color paper support having both surfaces laminated with a PE resin, which was a waterproof paper for printing paper manufactured by Fuji Photo Film Co., Ltd., and another, additional PP resin at the ratios by weight shown in Table 6. Molded products for a light-sensitive material were injection-molded. The waterproof paper for printing paper used here was a waterproof paper made by laminating 25 parts by weight of a PE resin relative to 75 parts by weight of a base paper. The maximum injection pressure during the injection molding was measured and the results are given in Table 7.

TABLE 6

| | | | Base-paper- |
|---|---|---|---|
| | Waterproof paper for | Additional PP | derived cellulose |
| No. | printing paper wt % | resin wt % | fiber content wt % |
| 1 | 0 | 100 | 0 |
| 2 | 13 | 87 | 10 |
| 3 | 27 | 73 | 20 |
| 4 | 40 | 60 | 30 |
| 5 | 53 | 47 | 40 |
| 6 | 67 | 33 | 50 |
| 7 | 80 | 20 | 60 |
| 8 | 93 | 7 | 70 |
| 9 | 100 | 0 | 75 |
| 10 | Base paper alone 80 | 20 | 80 |
| 11 | Base paper alone 90 | 10 | 90 |

When producing a paper resin having a base-paper-derived cellulose fiber content of 80 wt % or more, base paper without a laminated PE resin was used and the required amount of resin was added.

Paper resins made from recycled newspaper, which were comparative examples, were produced by adding a PP resin to the paper resin so that the recycled newspaper content became 0 to 90 wt % in accordance with the above-mentioned detailed production process example.

The injection pressures were measured when forming molded products for a light-sensitive material using the above-mentioned paper resins, and the results are given in Table 7.

TABLE 7

| Cellulose fiber | Waterproof paper for | Recycled |
|---|---|---|
| content wt % | printing paper MPa | newspaper MPa |
| 10 | 3.8 | 3.8 |
| 20 | 4.0 | 4.0 |
| 30 | 5.8 | 5.8 |
| 40 | 6.0 | 6.0 |
| 50 | 6.4 | 7.0 |
| 60 | 6.8 | 8.8 |
| 70 | 7.5 | 9.5 |
| 80 | 8.4 | 12.5 |
| 90 | 12.6 | 15.1 |

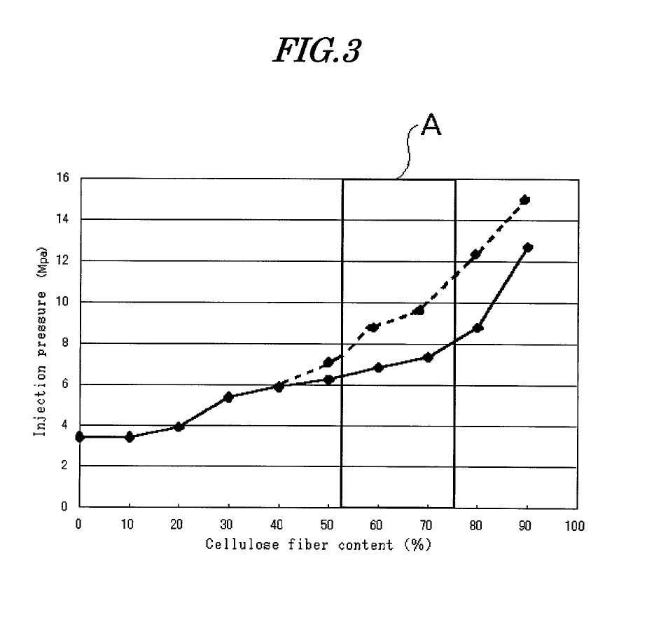

FIG. 3 is a graph showing the above-mentioned results, in which the proportion of cellulose fibers in the paper resin is plotted against the injection pressure when molding was carried out at a resin temperature of 170° C.

From this figure it was found that when the base-paper-derived cellulose fiber content exceeded 75 wt % the injection pressure rose rapidly and exceeded 9 MPa, thereby making molding difficult. It is therefore desirable for the upper limit for the base-paper-derived cellulose fiber content to be 75 wt %.

### Example 5

Hardwood bleached kraft pulp having a weight-average fiber length of 0.7 mm before beating was beaten and made into four types of base paper using various types of additive (a sizing agent such as a rosin or a higher fatty acid, a paper strength increasing agent such as polyacrylamide, a stabilizer such as aluminum sulfate) and sodium hydroxide so that the pH on the paper surface so obtained was 5, 6, 7, and 8. A waterproof paper for printing paper was obtained by laminating 25 parts by weight of a polyolefin resin on 75 parts by weight of each base paper.

The waterproof paper for printing paper so obtained was made into a broken material by a treatment according to the above-mentioned detailed production process example steps (1), (2), (3), and (4). Paper resin pellets were produced by adding 47 parts by weight of a PP resin (Idemitsu J6083HP) to 100 parts by weight of the broken material and subjecting the mixture to the treatments in the above-mentioned detailed production process example steps (5) and (6). Instant film packs and dumbbell pieces were molded in a Sumitomo GS180 molding machine using the paper resin pellets. The paper resin temperature during molding was at two levels; 1700° C. and 190° C.

The flexural strength was measured using the dumbbell pieces obtained by molding, and the photographic properties were evaluated using the instant film packs. The results of the evaluation are given in Table 8.

Izod impact values were obtained by the same test method and measurement conditions as those in Example 1.

From these results it was found that base paper having a pH in the vicinity of 7 gave the most stable results. When molding was carried out at a high temperature of 190° C, a paper resin made from a base paper having a low pH was susceptible to decomposition of the cellulose and its characteristic values were degraded.

TABLE 8

| | Molding temp. | Base paper pH | | | |
|---|---|---|---|---|---|
| | ° C. | 5 | 6 | 7 | 8 |
| Photographic property | 170 | 0.09 | 0.05 | 0.02 | 0.02 |
| ΔDmax | 190 | 0.13 | 0.11 | 0.10 | 0.13 |
| Izod impact value | 170 | 2.0 | 2.1 | 2.2 | 2.2 |
| KJ/m² | 190 | 1.85 | 1.9 | 2.0 | 1.95 |

### Example 6

A waterproof paper for printing paper, formed by laminating a polyolefin resin on a base paper that had been produced as a printing paper using hardwood bleached kraft pulp having a weight-average fiber length of 0.7 mm before breaking as measured using an FS-100 measuring machine manufactured by Kajaani Co., was broken using a pin mill and then subjected to pellet mill and turbomill treatments to give a broken material. A mixture of 100 parts by weight of the broken material and 37 parts by weight of a PP resin (Idemitsu M160) was subjected to a pellet mill treatment and then an extruder treatment using a uniaxial kneader to give paper resin pellets. The waterproof paper for printing paper was formed by laminating 25 parts by weight of a PE resin on 75 parts by weight of base paper.

A moisture-proof layer was molded in advance by a GS-180 molding machine (manufactured by Sumitomo Heavy Industries, Ltd.) using BC-3B PP resin (manufactured by Polyolefin Co.). The thickness of the lining layer was 0.2 mm. The moisture-proof layer was inserted in a case main body die attached to the GS-180 molding machine, and a case for housing a 135 format photographic film was injection-molded using the paper resin pellets.

The percentage weight of the total of the thermoplastic resin components relative to the total weight of the photographic film case was 49 wt %.

The container main body was loaded with 10.0 g of calcium chloride for measurement of the moisture proofness together with a FUJICOLOR SUPERIA 400 135 format film, and then fitted with a cap to complete a sealed product. The sample so obtained was allowed to stand in an oven at 40° C. and 90% RH for 24 hours, the weight of the calcium chloride was measured to determine the increase in weight, and the moisture permeability was found to be 0.2 g/m² ·day by conversion.

### Example 7

A die slide injection type die for a 135 format photographic film case was made, and molding was carried out using a JSWJ-150EII-P two-color molding machine.

A first hopper was charged with the same paper resin pellets as those of Example 6, and a second hopper with BC-3B PP resin (manufactured by Polyolefin Co.). A primary molded product (case main body) was molded by primary injection using the paper resin, and the die was opened while keeping the primary molded product in the cavity. After sliding the die to a position where the primary molded products faced each other, the die was closed again. The primary molded product pieces were made to oppose each other, and the PP resin was secondarily injected along the outer walls to integrate them, thereby providing a moisture-proof case for a photographic film, the case having a lining layer on the outside.

The thickness of the lining layer formed by the secondary injection was 0.1 mm. The percentage weight of the total of the resins relative to the total weight of the moisture-proof photographic film container was 46 wt %.

The photographic properties of the case were evaluated by the same method as in Example 6, and the moisture permeability was 0.27 g/m²·day.

### Example 8

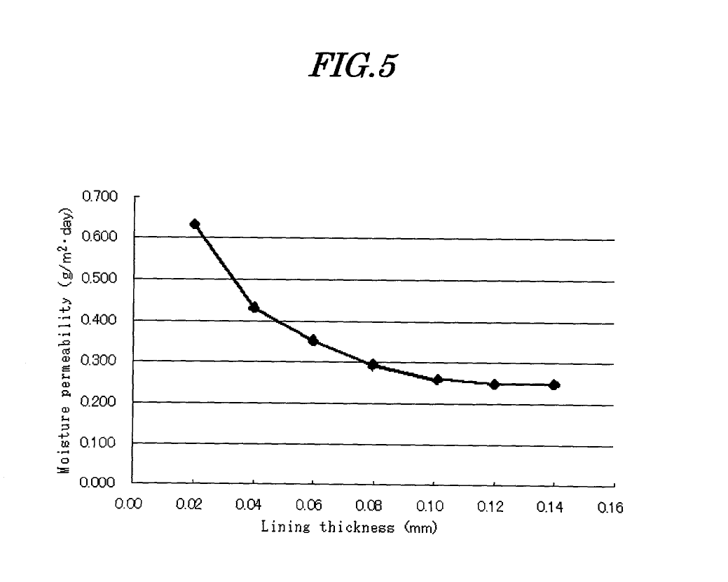

The procedure of Example 7 was repeated except that the thickness of the lining layer was changed, and the moisture permeability was examined. The results are given in FIG. 5.

Although embodiments of the present invention have been explained above, the present invention is not limited by the above-mentioned embodiments, and the present invention can be modified in a variety of ways without departing from the spirit and scope of the appended claims.

What is claimed is:

1. A molded product for a light-sensitive material made by a process comprising steps of:
breaking a waterproof paper for printing paper, the waterproof paper being obtained by laminating a base paper produced for printing paper with a polyolefin resin, to give a mixture of cellulose fibers and the polyolefin resin;
adding an additional thermoplastic resin to the mixture if necessary; and
molding so that the ratio by weight of the base-paper-derived cellulose fibers to the total of the polyolefin resin and the additional thermoplastic resin is in the range of 51:49 to 75:25.

2. The molded product for a light-sensitive material according to claim 1, wherein the mixture alone is temporarily formed into pellets, and these pellets and the additional thermoplastic resin are kneaded and molded.

3. The molded product for a light-sensitive material according to claim 2, wherein the weight-average fiber length of the cellulose fibers after breaking is in the range of 0.30 mm to 0.50 mm.

4. The molded product for a light-sensitive material according to claim 1, wherein the waterproof paper for printing paper is made from hardwood bleached kraft pulp having a cellulose fiber weight-average fiber length before breaking in the range of 0.4 mm to 0.7 mm, and the waterproof paper for printing paper is broken by a refiner.

5. The molded product for a light-sensitive material according to claim 1, wherein the base paper is a neutral paper that is made in a neutral region where the pH is in the range of 6.0 to 7.5.

6. A light-sensitive material package comprising:
a molded product for a light-sensitive material according to claim 1; and
a light-sensitive material that is used with the molded product.

7. The light-sensitive material package according to claim 6, wherein the mixture alone is temporarily formed into pellets, and these pellets and the additional thermoplastic resin are kneaded and molded.

8. The light-sensitive material package according to claim 7, wherein the weight-average fiber length of the cellulose fibers after breaking is in the range of 0.30 mm to 0.50 mm.

9. The light-sensitive material package according to claim 8, wherein the waterproof paper for printing paper is made from hardwood bleached kraft pulp having a cellulose fiber weight-average fiber length before breaking in the range of 0.4 mm to 0.7 mm, and the waterproof paper for printing paper is broken by a refiner.

10. The light-sensitive material package according to claim 6, wherein the base paper is a neutral paper that is made in a neutral region where the pH is in the range of 6.0 to 7.5.

11. A moisture-proof container for a light-sensitive material comprising:
a container for a light-sensitive material and a moisture-proof lining layer that are molded so that the ratio by weight of base-paper-derived cellulose fibers to the total thermoplastic resins is in the range of 51:49 to 75:25.

12. The moisture-proof container for a light-sensitive material according to claim 11, wherein the thickness of the moisture-proof lining layer is in the range of 0.05 to 0.2 mm.

13. The moisture-proof container for a light-sensitive material according to claim 11, wherein the lining layer is provided by a two-color molding method.

14. The moisture-proof container for a light-sensitive material according to claim 11, wherein the lining layer is provided by an insert-molding method.

15. A light-sensitive material package comprising:
a moisture-proof container for a light-sensitive material comprising a container for a light-sensitive material and a moisture-proof lining layer that are molded so that the ratio by weight of base-paper-derived cellulose fibers to the total thermoplastic resins is in the range of 51:49 to 75:25; and
a light-sensitive material that is housed in the container.

16. The light-sensitive material package according to claim 15, wherein the thickness of the moisture-proof lining layer is in the range of 0.05 to 0.2 mm.

17. The light-sensitive material package according to claim 15, wherein the lining layer is provided by a two-color molding method.

18. The light-sensitive material package according to claim 15, wherein the lining layer is provided by an insert-molding method.
